(19) United States
(12) Patent Application Publication
(10) Pub. No.: US 2012/0328080 A1
(43) Pub. Date: Dec. 27, 2012

(54) RADIOGRAPHIC IMAGING SYSTEM, CONNECTING MEMBER, RADIOGRAPHIC IMAGING DEVICE, POWER SOURCE SUPPLY SWITCHING METHOD AND COMPUTER READABLE MEDIUM STORING A PROGRAM

(75) Inventors: Jun ENOMOTO, Kanagawa (JP); Tatsuya KONAGAYA, Kanagawa (JP); Yutaka YOSHIDA, Kanagawa (JP); Yusuke KITAGAWA, Kanagawa (JP); Katsumi SHIMADA, Kanagawa (JP); Masaru SATO, Kanagawa (JP)

(73) Assignee: FUJIFILM CORPORATION, Tokyo (JP)

(21) Appl. No.: 13/484,012

(22) Filed: May 30, 2012

(30) Foreign Application Priority Data
Jun. 24, 2011 (JP) 2011-140739

(51) Int. Cl. H05G 1/56

(52) U.S. Cl. 378/114; 378/204

(57) ABSTRACT

There is provided a radiographic imaging system including: a radiographic imaging device having a built-in power source for driving, and a connection portion for wired connection; a connecting member that is structured so as to be able to be connected to the connection portion; and a cut-off section that, if the connecting member is connected to the connection portion, cuts-off supply of electric power from the built-in power source at the radiographic imaging device.

### CROSS-REFERENCE TO RELATED APPLICATION

This application is based on and claims priority under 35 USC 119 from Japanese Patent Application No. 2011-140739 filed on Jun. 24, 2011, the disclosure of which is incorporated by reference herein.

### BACKGROUND

1. Technical Field

The present invention relates to a radiographic imaging system, a connecting member, a radiographic imaging device, a power source supply switching method and a computer readable medium on which a program is stored. In particular, the present invention relates to a radiographic imaging system having a radiographic imaging device that is provided with a built-in power source for driving and a connection portion for wired connection, and a connecting member that is connected to the connection portion for wired connection of the radiographic imaging device, and the radiographic imaging device, and a power source supply switching method that switches the state of the supply of electric power from the built-in power source, and a computer readable medium on which is stored a program that is executed at the radiographic imaging device or the connecting member.

2. Related Art

Conventionally, portable radiographic imaging devices are provided with a built-in power source that supplies electric power for driving to a radiation detector and the like that are incorporated therein.

Among such radiographic imaging devices, there are those that do not have a power switch in order to ensure the sealability so as to prevent erroneous operation at the time of imaging and the penetration of blood or the like. Among such radiographic imaging devices, there are those in which electric power is usually supplied from a built-in power source to the respective portions that are driven by electric power, such as a radiation detector and the like.

However, such radiographic imaging devices have the problem that electric power from the built-in power source is consumed wastefully when the period of time over which imaging is not carried out is relatively long, such as when imaging is carried out through the lunch hour or when the device is moved on a cart for medical rounds or the like.

To address this, Japanese Patent Application Laid-Open (JP-A) No. 2005-6979 discloses a radiographic imaging device at which a cable, that has both a power supply line that transfers electric power supplied from the exterior and a data communication line imaging control signal line that transfers digital image data, can be connected to a cable connector. In this radiographic imaging device, when connection of the cable is sensed, the device main body selects that the battery that is built in the device main body is not to be used as the power source of the device main body.

However, in the technique disclosed in JP-A No. 2005-6979, in order to curb the amount of electric power that is consumed, the cable must be connected to the radiographic imaging device, and there is the problem that the work is bothersome.

It has also been thought to transmit, to a radiographic imaging device from a console that is structured so as to be able to communicate with the radiographic imaging device, an instruction to cut-off the supply of electric power from the built-in power source at times of non-use, and thereby cut-off this supply of electric power. However, in this case, there is the problem that the work for giving this instruction is bothersome.

Note that these problems are not limited to radiographic imaging devices that are not provided with a power switch, and are problems as well in radiographic imaging devices that have a power switch.

### SUMMARY

The present invention was developed in order to overcome the above-described problems, and an object thereof is to provide a radiographic imaging system, a connecting member, a radiographic imaging device, a power source supply switching method and a computer readable medium on which a program is stored, at which the amount of electric power that is consumed by a built-in power source can be curbed without being accompanied by bothersome work.

In order to achieve the above-described object, a first aspect of the present invention provides a radiographic imaging system including:

a radiographic imaging device having a built-in power source for driving, and a connection portion for wired connection;

a connecting member that is structured so as to be able to be connected to the connection portion; and

a cut-off section that, if the connecting member is connected to the connection portion, cuts-off supply of electric power from the built-in power source at the radiographic imaging device.

The radiographic imaging system of the first aspect of the present invention uses the connecting member that is structured so as to be able to be connected to the connection portion at the radiographic imaging device that has the built-in power source for driving and the connection portion for wired connection.

Further, in the present invention, when the connecting member is connected to the connection portion, the supply of electric power from the built-in power source at the radiographic imaging device is cut-off by the cut-off section.

In this way, in accordance with the radiographic imaging system of the first aspect of the present invention, when the connecting member is connected to the connection portion for wired connection of the radiographic imaging device, the supply of electric power from the built-in power source at the radiographic imaging device is cut-off. Therefore, merely by the simple work of attaching the connecting member, the amount of electric power that is consumed by the built-in power source can be curbed without being accompanied by bothersome work.

A second aspect of the present invention provides the radiographic imaging system of the first aspect, wherein

the connection portion is a portion to which is connected an external connection connector that is provided at a cable that connects the radiographic imaging device and an external device, and

the connecting member is a dummy connector of the external connection connector.

Due thereto, the connecting member of the present invention can be manufactured easily.

A third aspect of the present invention provides the radiographic imaging system of the second aspect, wherein the cable has at least a function of supplying electric power from an exterior.

Due thereto, in the state in which an external connection connector is connected to the connection portion, the supply of electric power from the exterior is possible. As a result, the amount of electric power that is consumed by the built-in power source can be curbed further.

A fourth aspect of the present invention provides the radiographic imaging system of the third aspect, further including:

a switching section that, if the external connection connector is connected to the connection portion, carries out switching such that electric power is supplied from the cable instead of the built-in power source.

Due thereto, the amount of electric power that is consumed by the built-in power source can be curbed more reliably.

A fifth aspect of the present invention provides the radiographic imaging system of the first aspect, further including:

a transmitting section that, if the connecting member is connected to the connection portion, transmits power source cut-off information that expresses that the supply of electric power from the built-in power source is to be cut-off,

wherein the cut-off section cuts-off the supply of electric power from the built-in power source after the power source cut-off information is transmitted by the transmitting section.

Due thereto, an external device can be made to grasp that the supply of electric power is cut-off due to the connecting member being connected, and not that the supply of electric power is cut-off due to a problem or the like with the radiographic imaging device.

A sixth aspect of the present invention provides the radiographic imaging system of the first aspect, wherein the connecting member has a switch for switching a state of supplying and cutting-off of electric power from the built-in power source.

Due thereto, the convenience for the user can be improved more.

A seventh aspect of the present invention provides the radiographic imaging system of the first aspect, wherein the cut-off section is provided at the radiographic imaging device or the connecting member.

Due thereto, the space required for the cut-off section can be reduced as compared with a case in which the cut-off section is provided separately therefrom.

An eighth aspect of the present invention provides the radiographic imaging system of the first aspect, wherein the cut-off section electrically cuts-off the supply of electric power from the built-in power source.

A ninth aspect of the present invention provides the radiographic imaging system of the first aspect, wherein the cut-off section mechanically cuts-off the supply of electric power from the built-in power source.

Due thereto, when the supply of electric power is cut-off electrically, the durability of the cut-off section can be improved as compared with a case in which the supply of electric power is cut-off mechanically. On the other hand, when the supply of electric power is cut-off mechanically, electric power that is consumed for this cutting-off can be prevented from being generated as compared with a case in which the supply of electric power is cut-off electrically.

A tenth aspect of the present invention provides the radiographic imaging system of the first aspect, wherein, during when the connecting member is connected to the connection portion, the connecting member seals a periphery of a region of connection.

Due thereto, liquids such as blood and the like can be prevented from flowing into the device interior when the radiographic imaging device is used in an actual medical setting.

An eleventh aspect of the present invention provides the radiographic imaging system of the first aspect, further including:

a restarting section that, if the connecting member is detached from the connection portion, restarts the supply of electric power from the built-in power source at the radiographic imaging device.

Due thereto, bothersome operation can be avoided even more reliably.

A twelfth aspect of the present invention provides a connecting member including:

a second connection portion that is connected to a first connection portion for wired connection of a radiographic imaging device that has a built-in power source for driving and the connection portion; and

a cut-off section that, if the second connection portion is connected to the first connection portion, cuts-off supply of electric power from the built-in power source at the radiographic imaging device.

In accordance with the connecting member of the twelfth aspect of the present invention, the second connection portion is connected to the connection portion for wired connection of a radiographic imaging device that has a built-in power source for driving and the connection portion.

Here, in the present invention, when the second connection portion is connected to the connection portion, the supply of electric power from the built-in power source at the radiographic imaging device is cut-off by the cut-off section.

In this way, in accordance with the connecting member of the twelfth aspect of the present invention, when the connecting member is connected to the connection portion for wired connection of a radiographic imaging device, the supply of electric power from the built-in power source at the radiographic imaging device is cut-off. Therefore, merely by the simple work of attaching the connecting member, the amount of electric power that is consumed by the built-in power source can be curbed without being accompanied by bothersome work.

A thirteenth aspect of the present invention provides the connecting member of the twelfth aspect, further including:

a switch that switches a state between supplying and cutting-off of electric power from the built-in power source.

Due thereto, the convenience for the user can be improved more.

A fourteenth aspect of the present invention provides a radiographic imaging device including:

a built-in power source for driving;

a connection portion for wired connection; and

a cut-off section that cuts-off supply of electric power from the built-in power source if a connecting member, that is structured so as to be able to be connected to the connection portion, is connected to the connection portion.

In accordance with the radiographic imaging device of the fourteenth aspect of the present invention, when the connecting member, that is structured so as to be able to be connected to the connection portion for wired connection, is connected to the connection portion, the supply of electric power from the built-in power source for driving is cut-off by the cut-off section.

In this way, in accordance with the radiographic imaging device of the fourteenth aspect of the present invention, the supply of electric power from the built-in power source for driving is cut-off when the connecting member, that is structured so as to be able to be connected to the connection portion for wired connection, is connected to the connection portion. Therefore, merely by the simple work of attaching the connecting member, the amount of electric power that is consumed by the built-in power source can be curbed without being accompanied by bothersome work.

A fifteenth aspect of the present invention provides a power source supply switching method comprising:

cutting off supply of electric power from a built-in power source for driving at a radiographic imaging device that has the built-in power source and a connection portion for wired connection, if a connecting member, that is structured so as to be able to be connected to the connection portion, is connected to the connection portion; and

restarting the supply of electric power from the built-in power source if the connecting member is detached from the connection portion.

Accordingly, because the power source supply switching method of the fifteenth aspect of the present invention operates similarly to the invention of the first aspect, in the same way as the invention of the first aspect, the amount of electric power that is consumed by the built-in power source can be curbed without being accompanied by bothersome work.

A sixteenth aspect of the present invention provides a computer readable medium that stores a program for causing a computer to function as:

a cut-off section that cuts-off supply of electric power from a built-in power source for driving at a radiographic imaging device that has the built-in power source and a connection portion for wired connection, if a connecting member, that is structured so as to be able to be connected to the connection portion, is connected to the connection portion; and

a restarting section that restarts the supply of electric power from the built-in power source if the connecting member is detached from the connection portion.

Accordingly, because the computer readable medium that stores a program of the sixteenth aspect of the present invention operates similarly to the invention of the first aspect, in the same way as the invention of the first aspect, the amount of electric power that is consumed by the built-in power source can be curbed without being accompanied by bothersome work.

In accordance with the present invention, when a connecting member is connected to a connection portion for wired connection of a radiographic imaging device, the supply of electric power from the built-in power source at the radiographic imaging device is cut-off. Therefore, the effect is obtained that, merely by the simple work of attaching the connecting member, the amount of electric power that is consumed by the built-in power source can be curbed without being accompanied by bothersome work.

### BRIEF DESCRIPTION OF THE DRAWINGS

Exemplary embodiments of the present invention will be described in detail based on the following figures, wherein:

FIG. 1 is a block diagram showing the structure of a radiographic imaging system relating to an exemplary embodiment;

FIGS. 2A and 2B are front views showing the structures of an electronic cassette and a communication cable relating to the exemplary embodiment, and the method of connecting the communication cable to the electronic cassette;

FIG. 3 is a front view showing the structure of a dummy connector relating to the exemplary embodiment, and the method of connecting the dummy connector to the electronic cassette;

FIGS. 4A and 4B are transparent front views showing the structures of the communication cable and the dummy connector relating to the exemplary embodiment;

FIG. 5 is a block diagram (a partial circuit diagram) showing the structure of main portions of the electrical system of the electronic cassette relating to a first exemplary embodiment, and the method of connecting the communication cable and the dummy connector to the electronic cassette;

FIG. 6 is a circuit diagram showing the structure of a power source switching section relating to the first exemplary embodiment;

FIG. 7 is a circuit diagram showing the structure in a case in which the communication cable is connected to the electronic cassette relating to the first exemplary embodiment;

FIG. 8 is a circuit diagram showing the structure in a case in which the dummy connector is connected to the electronic cassette relating to the first exemplary embodiment;

FIG. 9 is a block diagram (a partial circuit diagram) showing the structure of main portions of the electrical system of the electronic cassette relating to a second exemplary embodiment, and the method of connecting the communication cable and the dummy connector to the electronic cassette;

FIG. 10 is a circuit diagram showing the structure of a power source switching section relating to the second exemplary embodiment, and the structure in a case in which the dummy connector is connected;

FIG. 11 is a flowchart showing the flow of processings of a power source switching processing program relating to the second exemplary embodiment;

FIG. 12 is a front view showing the structure of a dummy connector relating to a third exemplary embodiment;

FIG. 13 is a flowchart showing the flow of processings of a processing program at the time of switch operation relating to the third exemplary embodiment;

FIG. 14 is a circuit diagram showing the structure of a modified example of the dummy connector relating to the third exemplary embodiment;

FIG. 15 is a circuit diagram showing the structure of a modified example of the communication cable relating to the third exemplary embodiment;

FIG. 16 is a circuit diagram showing the structure of the electronic cassette relating to a fourth exemplary embodiment and the structure in a case in which a dummy connector is connected;

FIG. 17 is a block diagram (a partial circuit diagram) showing structural examples of another dummy connector and electronic cassette; and

FIG. 18 is a front view showing a structural example of another connecting member.

### DETAILED DESCRIPTION

Exemplary embodiments of the present invention are described in detail hereinafter with reference to the drawings. Note that, here, examples are described of cases in which the present invention is applied to a radiographic imaging system that carries out imaging of radiographic images by using a portable radiographic imaging device (hereinafter called “electronic cassette”).

### First Exemplary Embodiment

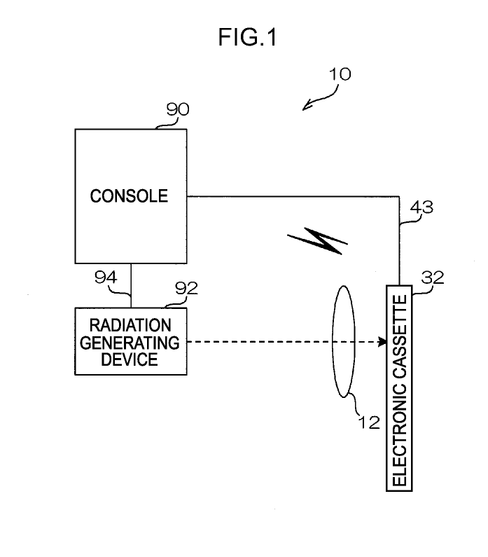

An example of the schematic structure of a radiographic imaging system 10 relating to the present exemplary embodiment is shown in FIG. 1.

As shown in FIG. 1, the radiographic imaging system 10 relating to the present exemplary embodiment is set in an imaging room (hereinafter called “X-ray room”) for capturing radiographic (in the present exemplary embodiment, X-ray) images. The radiographic imaging system 10 has an imaging control device (hereinafter called “console”) 90, a radiation generating device 92, and an electronic cassette 32.

The console 90 is structured so as to be able to carry out wireless communication with the electronic cassette 32. Further, the console 90 and the electronic cassette 32 can carry out wired communication in a state in which they are connected via a communication cable 43.

The console 90 carries out communication by either of a wired communication method or a wireless communication method, and carries out various types of control with respect to the electronic cassette 32 by transmitting control signals. Further, the console 90 is connected to the radiation generating device 92 via a communication cable 94, and controls the timing of the generating of radiation.

The radiation generating device 92 irradiates radiation onto a subject 12 at a timing based on the control of the console 90. The radiation, which is irradiated from the radiation generating device 92, is transmitted through the subject 12 and irradiated onto the electronic cassette 32. From the irradiated radiation, the electronic cassette 32 generates image data that expresses a radiographic image. The generated image data is transmitted to the console 90 by wired communication or wireless communication.

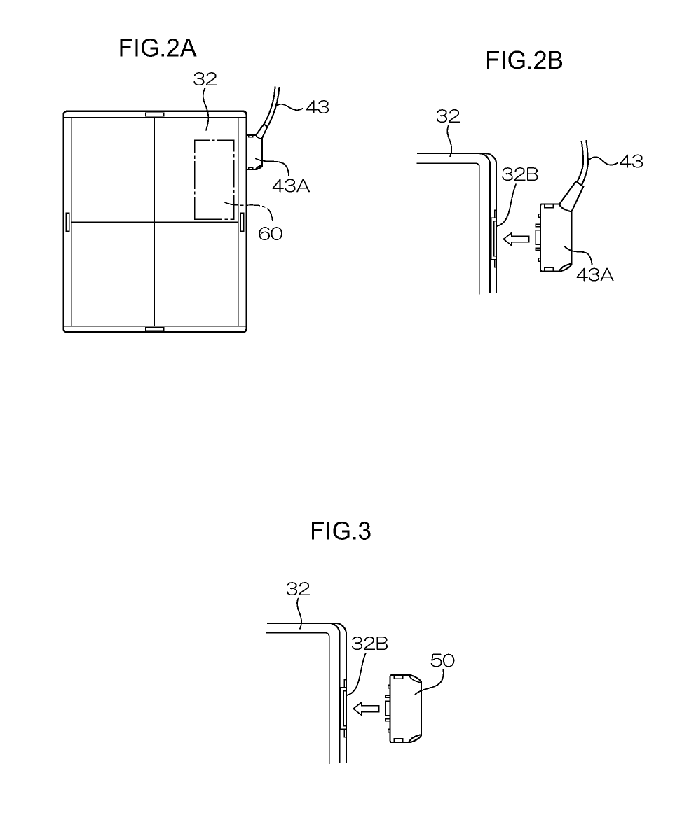

Front views showing the structures of the electronic cassette 32 and the communication cable 43 relating to the present exemplary embodiment, and the method of connecting the communication cable 43 to the electronic cassette 32, are shown in FIGS. 2A and 2B.

In order to prevent erroneous operation and to ensure sealability, a power switch is not provided at the electronic cassette 32 relating to the present exemplary embodiment. On the other hand, the electronic cassette 32 has a connection portion 32B to which a connector 43A that is provided at the communication cable 43 can be connected.

Note that, at the electronic cassette 32 relating to the present exemplary embodiment, electric power is usually supplied from a built-in power source 60 to the respective portions that are built in and that are driven by electric power, such as a radiation detector that will be described later and the like. On the other hand, when the connector 43A of the communication cable 43 is connected to the connection portion 32B, the supply of electric power from the built-in power source 60 to the aforementioned respective portions is cut-off, and electric power for driving the respective portions is supplied via the communication cable 43.

On the other hand, as shown in FIG. 3, a dummy connector 50, which is structured so as to be able to be connected to the connection portion 32B, is readied for the electronic cassette 32 relating to the present exemplary embodiment.

By connecting the dummy connector 50 to the electronic cassette 32, the supply of electric power from the built-in power source 60 of the electronic cassette 32 to the respective portions can be cut-off. Note that the dummy connector 50 relating to the present exemplary embodiment is essentially a connector whose specifications such as the shape, dimensions and the like are substantially the same as those of the connector 43A of the communication cable 43 that is connected to the connection portion 32B, but to which no cable is connected. In the state of being connected to the electronic cassette 32, the dummy connector 50 seals the periphery of this connection region.

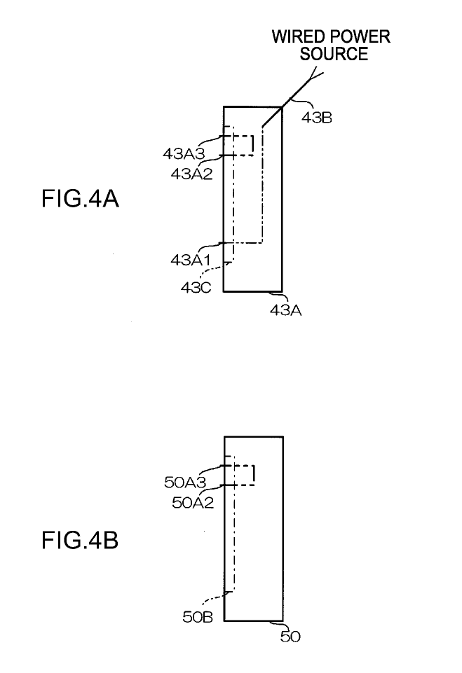

Transparent front views showing the structures of the connector 43A of the communication cable 43 and the dummy connector 50 relating to the present exemplary embodiment are shown in FIGS. 4A and 4B.

As shown in FIG. 4A, the connector 43A of the communication cable 43 relating to the present exemplary embodiment has a connection portion 43C. Provided at the connection portion 43C are an electric power output terminal 43A1 through which electric power that is supplied via a cable main body 43B is outputted, and a first terminal 43A2 for short-circuiting and a second terminal 43A3 for short-circuiting that are electrically connected to one another. Note that, although not illustrated, a signal line is provided at the cable main body 43B of the communication cable 43 relating to the present exemplary embodiment, in order for various types of control signals, image data obtained by imaging by the electronic cassette 32, and the like to be transmitted and received between the console 90 and the electronic cassette 32. A terminal, which is electrically connected to the end portion of this signal line, is also provided at the connection portion 43C.

Further, the dummy connector 50 relating to the present exemplary embodiment has a connection portion 50B that has the same specifications as the connection portion 43C provided at the connector 43A of the communication cable 43. A first terminal 50A2 for short-circuiting and a second terminal 50A3 for short-circuiting, which are electrically connected to one another, are provided at the connection portion 50B.

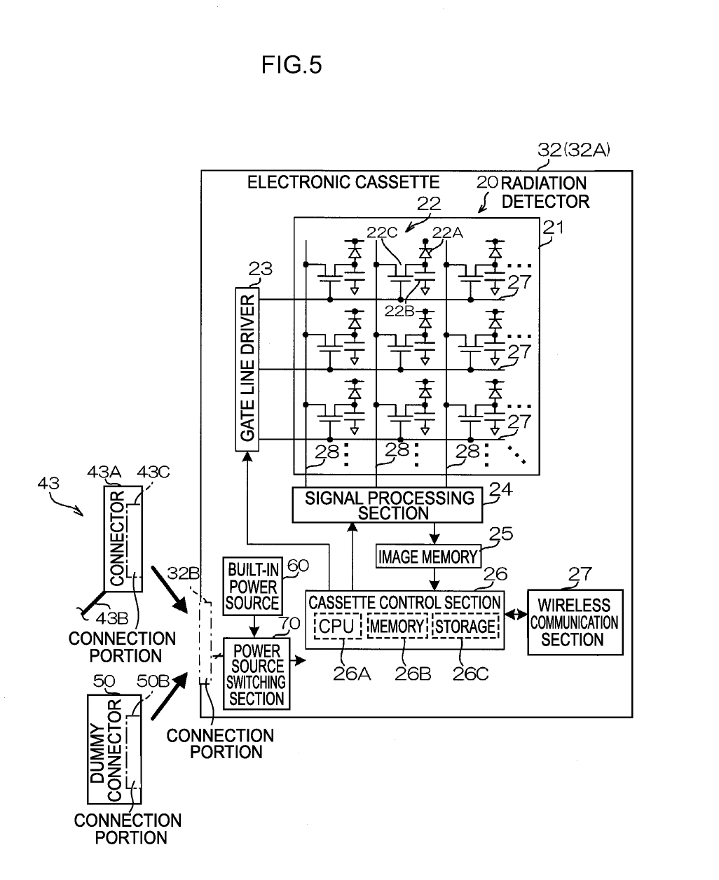

On the other hand, the structure of main portions of the electrical system of the electronic cassette 32, which relates to the present exemplary embodiment, are shown in FIG. 5.

As shown in FIG. 5, the electronic cassette 32 relating to the present exemplary embodiment has a radiation detector 20 at which an unillustrated scintillator is affixed on a TFT (Thin Film Transistor) substrate 21 by using an adhesive resin or the like that has low light absorption.

Plural pixels 22 are provided at the TFT substrate 21 in a two-dimensional form in a given direction (the row direction in FIG. 5) and a direction (the column direction in FIG. 5) that intersects the given direction. The pixel 22 is structured to include a sensor portion 22A that absorbs light generated at the scintillator and generates charges, a capacitor 22B that accumulates the charges generated at the sensor portion 22A, and a field-effect thin-film transistor (hereinafter simply called “thin-film transistor”) 22C that converts the charges accumulated in the capacitor 22B into electric signals and outputs the electric signals.

Plural gate lines 27, which extend in the aforementioned given direction (row direction) and are for turning the respective thin-film transistors 22C on and off, and plural data lines 28, which extend in the aforementioned intersecting direction (column direction) and are for reading-out charges via the thin-film transistors 22C that are in on states, are provided at the radiation detector 20. The radiation detector 20 is shaped as a flat plate, and, in plan view, is formed in a quadrilateral shape having four sides at the outer edges thereof, and more concretely, is formed in a rectangular shape.

At the radiation detector 20, a gate line driver 23 is disposed at one side of two adjacent sides, and a signal processing section 24 is disposed at the other side. The individual gate lines 27 of the TFT substrate 21 are connected to the gate line driver 23, and the individual data lines 28 of the TFT substrate 21 are connected to the signal processing section 24.

An image memory 25, a cassette control section 26, and a wireless communication section 27 are provided within a housing 32A of the electronic cassette 32.

The respective thin-film transistors 22C of the TFT substrate 21 are turned on in order in units of rows by signals supplied from the gate line driver 23 via the gate lines 27, and the charges that are read-out by the thin-film transistors 22C that have been turned on are transmitted as electric signals to the data lines 28 and are inputted to the signal processing section 24. Due thereto, the charges are read-out in order in units of rows, and a two-dimensional radiographic image can be acquired.

Although not shown in the drawings, the signal processing section 24 is equipped with an amplification circuit, that amplifies the inputted electric signal, and a sample hold circuit for each of the individual data lines 28. The electric signals that are transferred through the individual data lines 28 are amplified at the amplification circuits, and thereafter, are held in the sample hold circuits. Further, a multiplexer and an A/D (analog/digital) converter are connected in that order to the output sides of the sample hold circuits. The electric signals, which are held in the individual sample hold circuits, are inputted in order (serially) to the multiplexer, and are converted into digital image data by the A/D converter.

The image memory 25 is connected to the signal processing section 24. The image data outputted from the A/D converter of the signal processing section 24 is stored in order in the image memory 25. The image memory 25 has a storage capacity that can store image data of an amount of a predetermined number of images. Each time capturing of a radiographic image is carried out, the image data obtained by the capturing are successively stored in the image memory 25.

The image memory 25 is connected to the cassette control section 26. The cassette control section 26 is structured by a microcomputer, and has a CPU (Central Processing Unit) 26A, a memory 26B including a ROM (Read Only Memory) and a RAM (Random Access Memory), and a nonvolatile storage 26C formed by a flash memory or the like. The cassette control section 26 controls the overall operations of the electronic cassette 32.

The wireless communication section 27 is connected to the cassette control section 26. The wireless communication section 27 corresponds to wireless LAN (Local Area Network) standards exemplified by IEEE (Institute of Electrical and Electronics Engineers) 802.11a/b/g or the like, and controls the transfer of various types of information to and from external devices by wireless communication. Via the wireless communication section 27, the cassette control section 26 can carry out wireless communication with external devices such as the console 90 and the like, and can transmit and receive various types of information to and from the console 90 and the like.

The aforementioned built-in power source 60 is provided at the electronic cassette 32. Various types of circuits and respective elements (microcomputers and the like that function as the gate line driver 23, the signal processing section 24, the image memory 25, the wireless communication section 27, and the cassette control section 26), are operated by electric power supplied from the built-in power source 60. The built-in power source 60 incorporates therein a battery (a rechargeable secondary battery) so that the portability of the electronic cassette 32 is not impaired, and supplies electric power from the charged battery to the various types of circuits and respective elements.

On the other hand, a power source switching section 70, which is connected to the electric power output terminal of the built-in power source 60 and is connected to a terminal provided at the connection portion 32B, is provided at the electronic cassette 32 relating to the present exemplary embodiment.

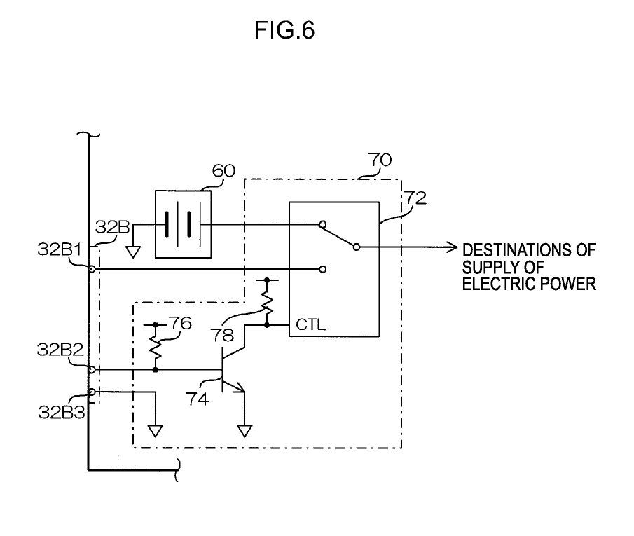

As shown in FIG. 6, the power source switching section 70 relating to the present exemplary embodiment has a two-input, one-output selector 72, a transistor 74, and two pull-up resistors 76, 78. One of the input terminals of the selector 72 is connected to the electric power output terminal of the built-in power source 60. Note that, at the selector 72 relating to the present exemplary embodiment, when the control terminal is low-level, one of the input terminals is connected to the output terminal, and when the control terminal is high-level, the other input terminal is connected to the output terminal. However, the logic of this selector 72 may be the opposite.

The connection portion 32B has an electric power input terminal 32B1 that is connected to the electric power output terminal 43A1 when the connector 43A of the communication cable 43 is connected, and, on the other hand, is in an open state when the dummy connector 50 is connected. The other input terminal of the selector 72 is connected to the electric power input terminal 32B1.

Similarly, the connection portion 32B has a first terminal 32B2 for short-circuiting that is connected to the first terminal 43A2 for short-circuiting when the connector 43A of the communication cable 43 is connected, and, on the other hand, contacts the first terminal 50A2 for short-circuiting when the dummy connector 50 is connected. Further, the connection portion 32B has a second terminal 32B3 for short-circuiting that contacts the second terminal 43A3 for short-circuiting when the connector 43A is connected, and, on the other hand, contacts the second terminal 50A3 for short-circuiting when the dummy connector 50 is connected. Moreover, the first terminal 32B2 for short-circuiting is connected to the base of the transistor 74, and via the pull-up resistor 76, is pulled-up to a predetermined voltage at which the transistor 74 can be set in an on state.

On the other hand, the collector of the transistor 74 is connected to the control terminal of the selector 72, and, via the pull-up resistor 78, is pulled-up to a predetermined voltage at which the control terminal of the selector 72 can be set in an on state (high-level). Note that the emitter of the transistor 74 is grounded.

Further, the second terminal 32B3 for short-circuiting is grounded. The output terminal of the selector 72 is connected to the input terminal of an unillustrated DC/DC converter that is interposed between the selector 72 and respective destinations of supply of electric power.

Note that, at the power source switching section 70 relating to the present exemplary embodiment, pull-up voltage from the built-in power source 60 is usually applied to the pull-up resistor 76 and the pull-up resistor 78.

Operation of the radiographic imaging system 10 relating to the present exemplary embodiment is described next. First, the operation of the electronic cassette 32 relating to the present exemplary embodiment at the time of capturing a radiographic image is described with reference to FIG. 5.

When capturing of a radiographic image is to be carried out, the electronic cassette 32 relating to the present exemplary embodiment is placed with an interval between the electronic cassette 32 and the radiation generating device 92, and the portion that is to be imaged of the subject 12 is disposed on the imaging region. Thereafter, the radiation generating device 92 emits radiation of a radiation amount corresponding to imaging conditions that are provided in advance and the like.

Due to the radiation, that is emitted from the radiation generating device 92, passing through the portion to be imaged, the radiation carries image information, and thereafter, is irradiated onto the electronic cassette 32. Due thereto, charges, which correspond to the amounts of radiation that is irradiated, are generated at the respective sensor portions 22A of the radiation detector 20 that is incorporated within the electronic cassette 32, and the charges generated at the sensor portions 22A are accumulated in the capacitors 22B.

After irradiation of radiation ends, the cassette control section 26 controls the gate line driver 23 such that on signals are outputted from the gate line driver 23 to the respective gate lines 27 of the radiation detector 20 in order and line-by-line, and image information is read-out. The image information read-out from the radiation detector 20 is converted into digital image data by the aforementioned A/D converter, and the digital image data is stored in the image memory 25, and thereafter, is wirelessly transmitted to the console 90 via the wireless communication section 27.

Operation of the electronic cassette 32 when nothing is connected to the connection portion 32B is described in detail next with reference to FIG. 6.

As shown in FIG. 6, at this time, the electric power input terminal 32B1 that is provided at the connection portion 32B of the electronic cassette 32 is in an open state, and, on the other hand, the first terminal 32B2 for short-circuiting and the second terminal 32B3 for short-circuiting also are in open states. As a result, the transistor 74 is in an on state, the control terminal of the selector 72 is low-level, and the aforementioned one input terminal at the selector 72 is in a state of being connected to the output terminal (the state shown in FIG. 6).

Due to the above-described operations, electric power from the built-in power source 60 is supplied via the aforementioned DC-DC converter and the like to the respective destinations of the supply of electric power of the electronic cassette 32.

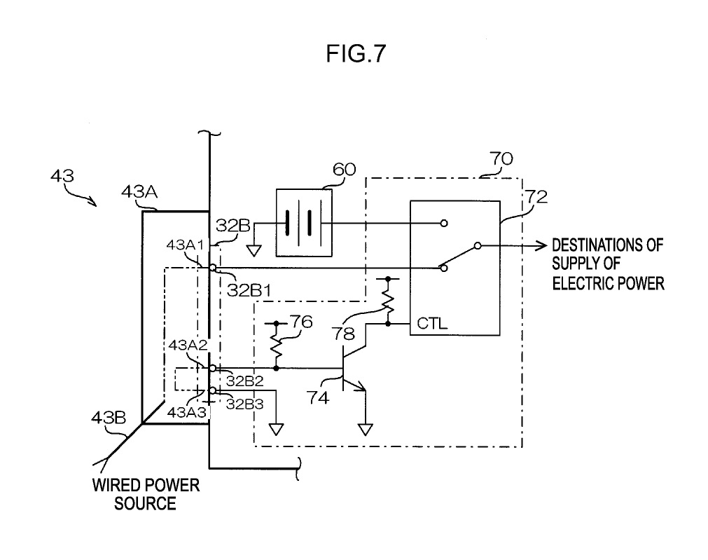

Next, the operation of the electronic cassette 32 when the communication cable 43 is connected to the connection portion 32B is described in detail with reference to FIG. 7.

As shown in FIG. 7, at this time, the electric power output terminal 43A1, which is provided at the connector 43A of the communication cable 43, contacts the electric power input terminal 32B1 that is provided at the connection portion 32B of the electronic cassette 32.

On the other hand, at this time, the first terminal 32B2 for short-circuiting and the second terminal 32B3 for short-circuiting, which are provided at the connection portion 32B, are short-circuited via the first terminal 43A2 for short-circuiting and the second terminal 43A3 for short-circuiting that are provided at the connector 43A. As a result, the transistor 74 is set in an off state, the control terminal of the selector 72 becomes high-level via the pull-up resistor 78, and there becomes a state in which the aforementioned other input terminal at the selector 72 is connected to the output terminal (the state shown in FIG. 7).

Due to the above-described operations, the supply of electric power from the built-in power source 60 is cut-off, whereas electric power inputted via the communication cable 43 is supplied via the aforementioned DC-DC converter and the like to the respective destinations of the supply of electric power of the electronic cassette 32.

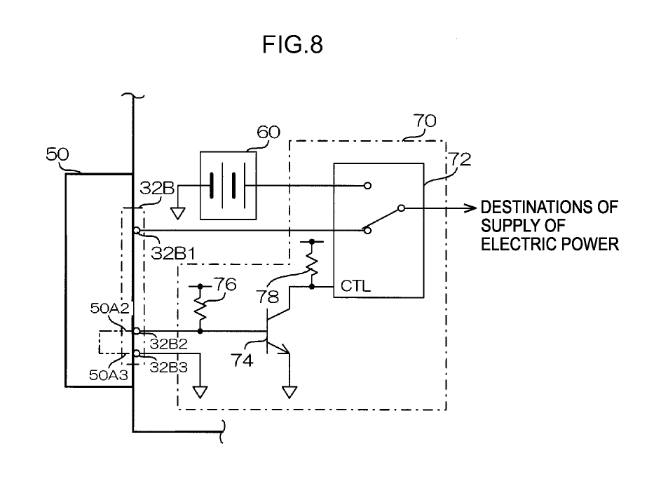

Next, the operation of the electronic cassette 32 when the dummy connector 50 is connected to the connection portion 32B is described in detail with reference to FIG. 8.

As shown in FIG. 8, at this time, the electric power input terminal 32B1 that is provided at the connection portion 32B is set in an open state.

On the other hand, at this time, the first terminal 32B2 for short-circuiting and the second terminal 32B3 for short-circuiting, which are provided at the connection portion 32B, are short-circuited via the first terminal 50A2 for short-circuiting and the second terminal 50A3 for short-circuiting that are provided at the dummy connector 50. As a result, the transistor 74 is set in an off state, the control terminal of the selector 72 becomes high-level via the pull-up resistor 78, and there becomes a state in which the aforementioned other input terminal at the selector 72 is connected to the output terminal (the state shown in FIG. 8).

Due to the above-described operations, the supply of electric power from the built-in power source 60 is cut-off, and electric power is not supplied to the respective destinations of the supply of electric power of the electronic cassette 32. Note that, here, when the dummy connector 50 is detached from the connection portion 32B, the supply of electric power from the built-in power source 60 is of course restarted.

As described above in detail, in accordance with the present exemplary embodiment, when the connecting member (here, the dummy connector 50) is connected to the connection portion for wired connection (here, the connection portion 32B) of the radiographic imaging device (here, the electronic cassette 32), the supply of electric power from the built-in power source (here, the built-in power source 60) at the radiographic imaging device is cut-off. Therefore, merely by the simple work of attaching the connecting member, the amount of electric power that is consumed by the built-in power source can be curbed without being accompanied by bothersome work.

Further, in accordance with the present exemplary embodiment, the connection portion is a portion to which is connected an external connection connector (here, the connector 43A) that is provided at a cable (here, the cable main body 43B) that connects the radiographic imaging device and an external device (here, the console 90), and the connecting member is the dummy connector of the external connection connector. Therefore, the connecting member can be manufactured easily.

In particular, in accordance with the present exemplary embodiment, the cable at least has the function of supplying electric power from the exterior. Therefore, in the state in which the external connection connector is connected to connection portion, the supply of electric power from the exterior becomes possible, and as a result, the amount of electric power that is consumed by the built-in power source can be curbed even more.

In particular, in accordance with the present exemplary embodiment, when the external connection connector is connected to the connection portion, switching is carried out such that electric power is supplied from the cable instead of from the built-in power source. Therefore, the amount of electric power that is consumed by the built-in power source can be curbed even more reliably.

Further, in accordance with the present exemplary embodiment, the cut-off section, which cuts-off the supply of electric power from the built-in power source, is provided at the connecting member. Therefore, the space required for the cut-off section can be reduced as compared with a case in which the cut-off section is provided separately.

Moreover, in accordance with the present exemplary embodiment, the supply of electric power from the built-in power source is electrically cut-off by the cut-off section. Therefore, the durability of the cut-off section can be improved as compared with a case in which the supply of electric power is cut-off mechanically.

Still further, in accordance with the present exemplary embodiment, when the connecting member is connected to the connection portion, the connecting member seals the periphery of the connection region. Therefore, when the radiographic imaging device is used in an actual medical setting, liquids such as blood and the like can be prevented from flowing into the device interior.

### Second Exemplary Embodiment

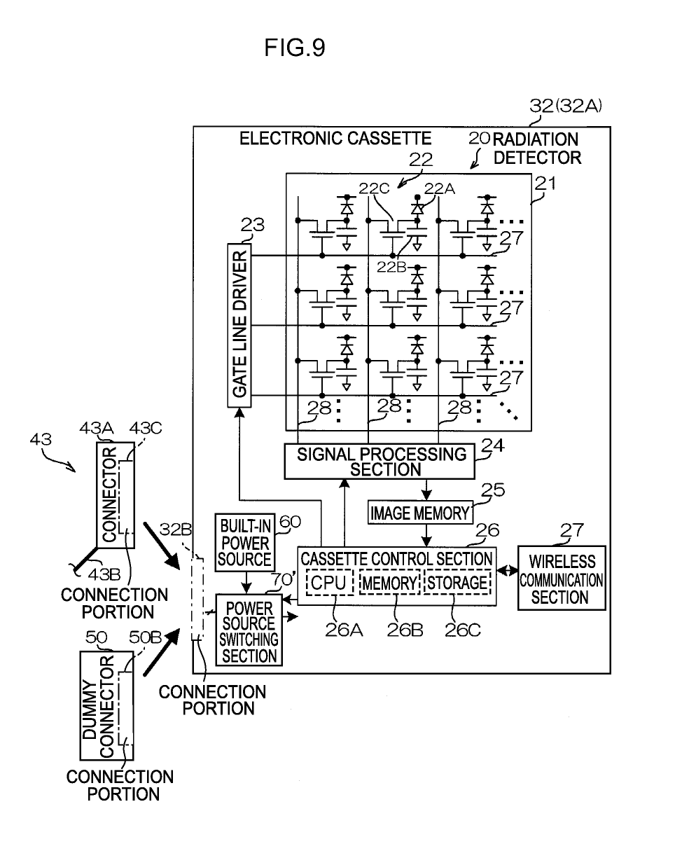

First, the structure of main portions of the electrical system of the electronic cassette 32 relating to the present second exemplary embodiment is described with reference to FIG. 9. Note that structural elements in FIG. 9 that are the same as in FIG. 5 are denoted by the same reference numerals as in FIG. 5, and description thereof is omitted.

As shown in FIG. 9, the electronic cassette 32 relating to the present second exemplary embodiment differs from the above-described first exemplary embodiment only with regard to the point that a power source switching section 70′, which has a different internal structure, is used instead of the power source switching section 70.

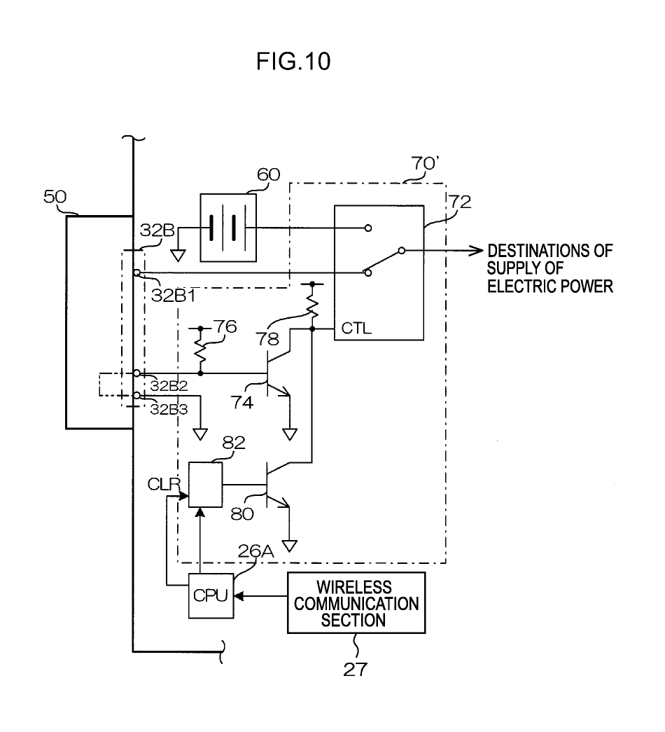

The structure of the power source switching section 70′ relating to the present second exemplary embodiment is shown in FIG. 10. Note that structural elements in FIG. 10 that are the same as in FIG. 6 are denoted by the same reference numerals as in FIG. 6, and description thereof is omitted as much as possible.

As shown in FIG. 10, the power source switching section 70′ has a transistor 80 and a register 82. The collector of the transistor 80 is connected to the control terminal of the selector 72, whereas the emitter is grounded.

The clear terminal and the input terminal of the register 82 are connected to the CPU 26A of the cassette control section 26, whereas the output terminal of the register 82 is connected to the base of the transistor 80.

In the power source switching section 70′ relating to the present second exemplary embodiment, portions other than the transistor 80 and the register 82 operate in the same way as the power source switching section 70 relating to the above-described first exemplary embodiment. Namely, in the state in which the dummy connector 50 is connected to the connection portion 32B, the electric power input terminal 32B1 provided at the connection portion 32B is in an open state, and the first terminal 32B2 for short-circuiting and the second terminal 32B3 for short-circuiting are short-circuited. As a result, the control terminal of the selector 72 is made to be high-level, and the supply of electric power from the built-in power source 60 is cut-off.

Here, in the power source switching section 70′ relating to the present second exemplary embodiment, the collector of the transistor 80, whose emitter is grounded and to whose base the output terminal of the register 82 is connected, is connected to the control terminal of the selector 72. Therefore, by setting data such that the output terminal becomes high-level at the register 82, the transistor 80 is set in an on state, the control terminal of the selector 72 can be made to be low-level, and, as a result, electric power from the built-in power source 60 is supplied via the aforementioned DC-DC converter and the like.

In contrast, by setting data such that the output terminal becomes low-level at the register 82, the transistor 80 is set in an off state, the control terminal of the selector 72 can be made to be high-level, and, as a result, the supply of electric power from the built-in power source 60 is cut-off.

Note that, in the electronic cassette 32 relating to the present exemplary embodiment, electric power for driving from the built-in power source 60 is usually inputted to the CPU 26A.

When the electronic cassette 32 relating to the present exemplary embodiment receives, from the console 90 and via the wireless communication section 27, built-in power source usage instructing information that instructs usage of the built-in power source 60, or built-in power source cut-off instructing information that instructs cutting-off of the supply of electric power from the built-in power source 60, the electronic cassette 32 executes power source switching processing that controls the state of the supply of electric power from the built-in power source 60, in accordance with the received information.

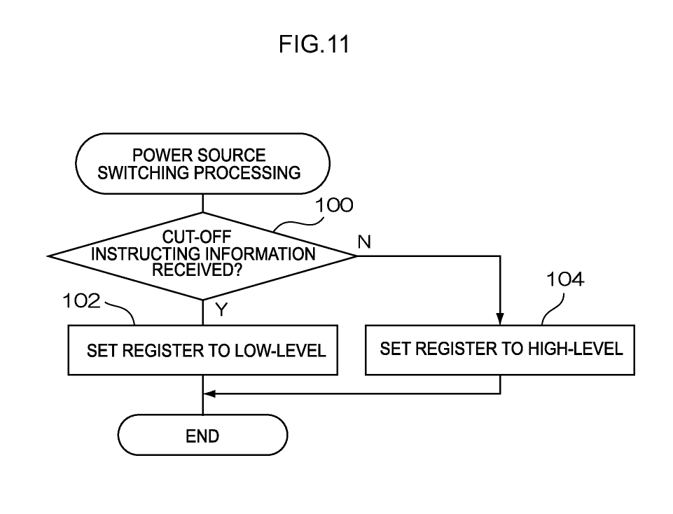

Next, operation of the electronic cassette 32 relating to the present second exemplary embodiment at the time when the power source switching processing is executed is described with reference to FIG. 11. Note that FIG. 11 is a flowchart showing the flow of processings of a power source switching processing program that is executed by the CPU 26A of the cassette control section 26 at this time, and this program is stored in advance in a predetermined area of the memory 26B that serves as a storage medium.

In step 100 of FIG. 11, it is judged whether or not information that is received from the console 90 is built-in power source cut-off instructing information. If the judgment is affirmative, the routine moves on to step 102 where information that causes the register 82 to output low-level is set, and thereafter, the present power source switching processing program ends.

On the other hand, if the judgment in above step 100 is negative, it is considered that the received information is built-in power source usage instructing information, and the routine moves on to step 104 where information that causes the register 82 to output high-level is set. Thereafter, the present power source switching processing program ends.

By executing the present power source switching processing program, the state of the supply of electric power from the built-in power source 60 can be controlled by the transmission of instruction information from the console 90.

As described above in detail, the present exemplary embodiment as well can achieve effects that are substantially similar to those of the above-described first exemplary embodiment, and the cut-off section, which cuts-off the supply of electric power from the built-in power source, is provided at the radiographic imaging device. Therefore, as compared with a case in which the cut-off section is provided separately, the space that is needed for the cut-off section can be reduced.

### Third Exemplary Embodiment

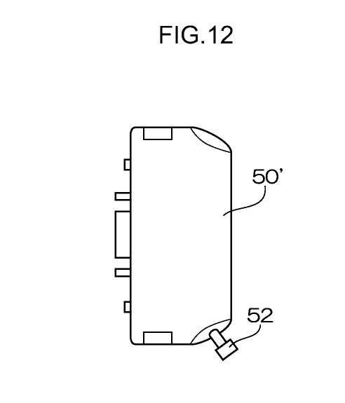

First, the structure of a dummy connector 50′, which is used in the radiographic imaging system relating to the present third exemplary embodiment, is described with reference to FIG. 12.

As shown in FIG. 12, the dummy connector 50′ relating to the present third exemplary embodiment differs from the dummy connector 50 relating to the above-described first exemplary embodiment only with regard to the point that a switch 52 is provided, in a state in which a pushing portion thereof is exposed at the exterior, at the dummy connector 50. Here, a so-called alternate-type switch, at which the on state and off state are switched each time the pushing portion is pushed and operated, is used as the switch 52. In the state in which the dummy connector 50′ is connected to the connection portion 32B, the electronic cassette 32 relating to the present exemplary embodiment can grasp the on/off state of the switch 52.

Because structures other than the dummy connector 50′ and the electronic cassette 32 are similar to the above-described second exemplary embodiment, description thereof is omitted here.

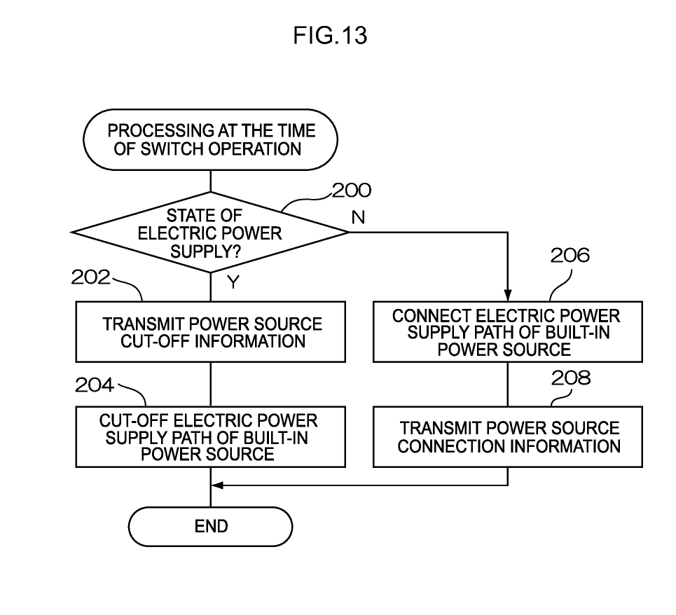

Next, operation of the electronic cassette 32 relating to the present third exemplary embodiment, when the dummy connector 50′ is connected to the connection portion 32B and the switch 52 of the dummy connector 50′ is pushed and operated, is described with reference to FIG. 13. Note that FIG. 13 is a flowchart that shows the flow of processings of a processing program at the time of switch operation, that is executed by the CPU 26A of the cassette control section 26 at this time, and this program is stored in advance in a predetermined area of the memory 26B.

In step 200 of FIG. 13, it is judged whether or not supply of electric power from the built-in power source 60 to the respective destinations of supply of electric power is being carried out. If the judgment is affirmative, the routine moves on to step 202 where power source cut-off information that expresses that the supply of electric power from the built-in power source 60 is to be cut-off, is transmitted via the wireless communication section 27 to the console 90. In next step 204, by setting information that causes the register 82 to output low-level, the supply of electric power from the built-in power source 60 is cut-off. Thereafter, the present program for processing at the time of switch operation ends.

On the other hand, when the judgment in above step 200 is negative, the routine moves on to step 206 where, by setting information that causes the register 82 to output high-level, the electric power supply path from the built-in power source 60 is connected. In next step 208, power source connection information, that expresses that the electric power supply path from the built-in power source 60 is connected, is transmitted to the console 90 via the wireless communication section 27. Thereafter, the present program for processing at the time of switch operation ends.

As described above in detail, the present exemplary embodiment can achieve effects that are similar to those of the above-described second exemplary embodiment, and, when the connecting member is connected to the connection portion, power source cut-off information that expresses that the supply of electric power from the built-in power source is to be cut-off is transmitted, and, after the power source cut-off information is transmitted, the supply of electric power from the built-in power source is cut-off. Therefore, an external device can be made to grasp that the supply of electric power has been cut-off due to the connecting member being connected, and not that the supply of electric power has been cut-off due to a problem or the like with the radiographic imaging device.

Further, in accordance with the present exemplary embodiment, a switch (here, the switch 52), for switching the state of supplying of or cutting-off of electric power from the built-in power source, is provided at the connecting member. Therefore, the convenience for a user can be improved more.

Note that the present third exemplary embodiment describes a case in which the power source cut-off information is transmitted when the dummy connector 50′ is connected to the electronic cassette 32 and the supply of electric power from the built-in power source 60 is to be cut-off in accordance with operation of the switch 52. However, the present invention is not limited to the same. There may be a form in which, when the dummy connector 50′ is connected to the electronic cassette 32, the power source cut-off information is transmitted, and thereafter, the supply of electric power from the built-in power source 60 is cut-off.

Further, the present third exemplary embodiment describes a case in which the switching of the state of the supply of electric power from the built-in power source 60 in accordance with the push-operation of the switch 52 that is provided at the dummy connector 50′, is executed by software processing by the CPU 26A. However, the present invention is not limited to the same, and there may be a form in which this switching of the state of the supply of electric power is realized by a circuit structure by electronic circuits.

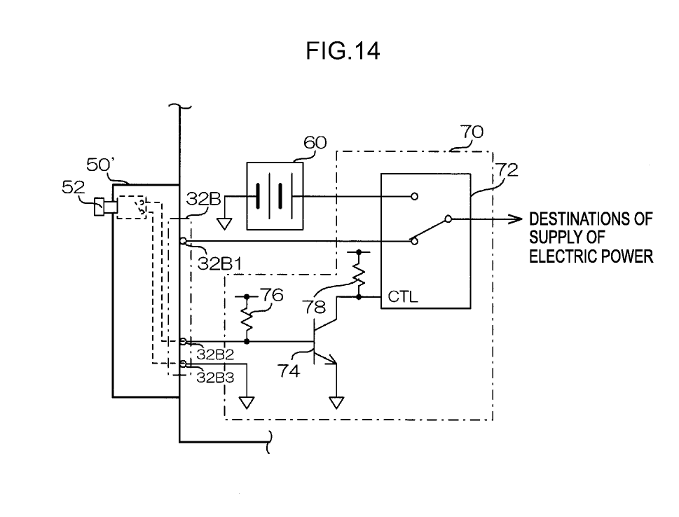

A structural example of the dummy connector 50′ in this case is shown in FIG. 14. Note that the structure of the power source switching section 70 of the electronic cassette 32 in this example is the same as that relating to the above-described first exemplary embodiment.

As shown in FIG. 14, at the dummy connector 50′ relating to this embodiment, in the state in which the dummy connector 50′ is connected to the connection portion 32B of the electronic cassette 32, of the pair of contacts at which the connected/disconnected state is switched in accordance with the pushing operation of the pushing portion of the switch 52, one of the contacts is connected to the first terminal 32B2 for short-circuiting at the connection portion 32B provided at the electronic cassette 32, whereas the other contact is connected to the second terminal 32B3 for short-circuiting.

Accordingly, a user can switch the on/off state of the transistor 74 by pushing and operating the pushing portion of the switch 52.

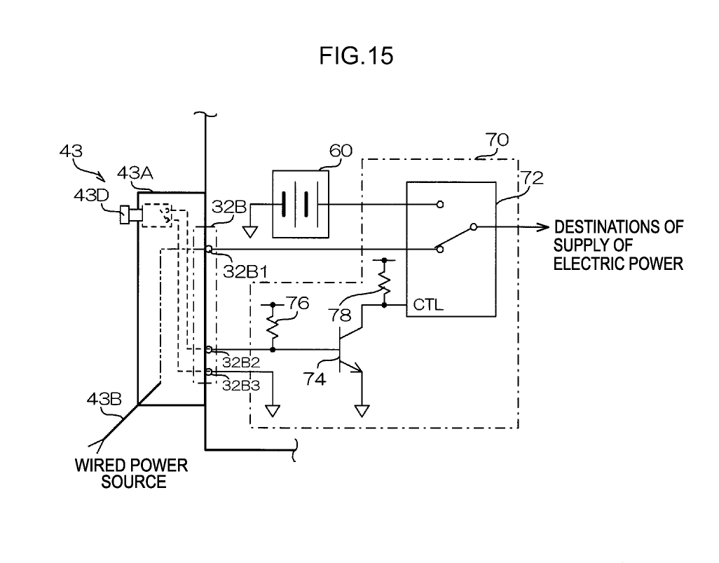

Note that, similarly, as shown in FIG. 15 as an example, there may be a structure in which a switch 43D, for switching the state of the supplying of and cutting-off of electric power from the built-in power source 60, is provided at the connector 43A of the communication cable 43, and the state of supplying electric power from the built-in power source 60 can be switched by pushing and operating this switch 43D.

### Fourth Exemplary Embodiment

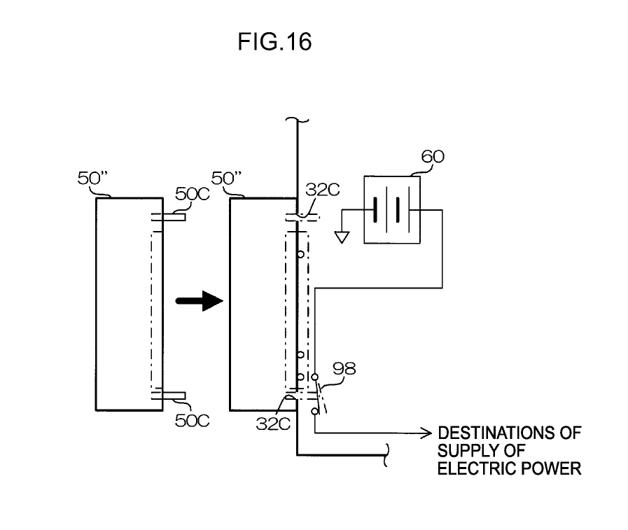

First, the structures of a dummy connector 50″ and the electronic cassette 32, which are used in the radiographic imaging system relating to the present fourth exemplary embodiment, are described with reference to FIG. 16.

As shown in FIG. 16, the dummy connector 50″ relating to the present fourth exemplary embodiment differs from the dummy connector 50 relating to above-described first exemplary embodiment only with regard to the point that the first terminal 50A2 for short-circuiting and the second terminal 50A3 for short-circuiting are not provided, and the point that a pair of positioning pins 50C are provided, with respect to the dummy connector 50.

On the other hand, at the electronic cassette 32 relating to the present exemplary embodiment, there are provided a pair of holes 32C in which the pair of positioning pins 50C are individually inserted when the dummy connector 50″ is connected. Further, at the electronic cassette 32 relating to the present exemplary embodiment, a switch 98 is interposed, on the path from the built-in power source 60 to the input terminal of the unillustrated DC/DC converter that is interposed between the built-in power source 60 and the respective destinations of supply of electric power, and at a position at which the switch 98 is set in an off state (disconnected state) by the distal end portion of one of the positioning pins 50C when the dummy connector 50″ is connected.

Note that, because the structures other than the dummy connector 50″ and the electronic cassette 32 are similar to those of the above-described first exemplary embodiment, description thereof is omitted there.

In the electronic cassette 32 relating to the present exemplary embodiment, in the state in which the dummy connector 50″ is not connected, the switch 98 is in an on state (the state shown by the solid line in FIG. 16), and electric power is usually supplied from the built-in power source 60 to the respective destinations of the supply of electric power.

In contrast, in the state in which the dummy connector 50″ is connected, the switch 98 is in an off state (the state shown by the one-dot chain line in FIG. 16) due to the distal end portion of one of the positioning pins 50C, and therefore, the supply of electric power from the built-in power source 60 to the respective destinations of the supply of electric power is cut-off.

As described above in detail, the present exemplary embodiment can achieve effects that are substantially similar to those of the above-described first exemplary embodiment, and the cut-off section mechanically cuts-off the supply of electric power from the built-in power source. Therefore, as compared with a case in which the cut-off section electrically cuts-off the supply of electric power, electric power that is consumed for this cutting-off can be prevented from being generated.

The present invention has been described above by using exemplary embodiments, but the technical scope of the present invention is not limited to the ranges described in the above exemplary embodiments. Various changes and improvements can be made to the exemplary embodiments within a range that does not deviate from the gist of the present invention, and forms to which such changes or improvements are made also are included within the technical scope of the present invention.

Further, the above-described exemplary embodiments do not limit the inventions relating to the claims, and it is not necessarily the case that all of the combinations of features described in the exemplary embodiments are essential to the means of the present invention for solving the problems of the prior art. Inventions of various stages are included in the above exemplary embodiments, and various inventions can be extracted by appropriately combining plural constituent features that are disclosed. Even if some of the constituent features are removed from all of the constituent features that are illustrated in the exemplary embodiments, such structures from which some constituent features are removed can be extracted as inventions provided that the effects of the present invention are obtained thereby.

For example, the above-described respective exemplary embodiments describe cases in which the state of supplying electric power from the built-in power source 60 is controlled by structures or processings at the electronic cassette 32 side. However, the present invention is not limited to the same, and may be a form in which the state of supplying electric power of the built-in power source 60 is actively controlled by the dummy connector.

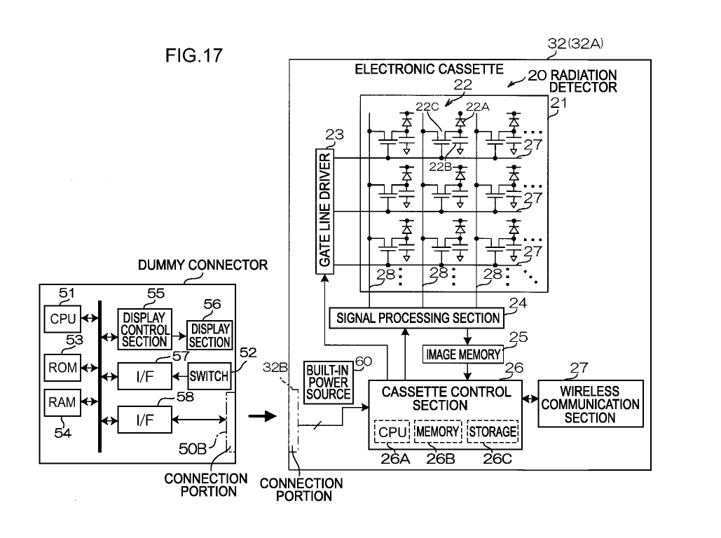

A structural example of the dummy connector and the electronic cassette 32 in this case is shown in FIG. 17. Note that, here, an example is given of a case in which the switch 52, which is similar to that of the dummy connector 50′ relating to the above-described third exemplary embodiment, is provided at the dummy connector, and a display section 56 that can display various types of information is provided at the dummy connector.

As shown in FIG. 17, the dummy connector has a CPU 51, a ROM 53 and a RAM 54, and has a display control section 55 that is connected to the display section 56, and an interface section (I/F) 57 that is connected to the switch 52. These respective sections are electrically connected to one another by a system bus. Accordingly, the CPU 51 can respectively carry out accessing of the ROM 53 and the RAM 54, display of various types of information on the display section 56, and grasping of the state of the switch 52.

Further, the dummy connector has an I/F 58 that is connected to the connection portion 50B, and this I/F 58 also is connected to the aforementioned system bus. Accordingly, the CPU 51 can carry out transfer of various types of information to and from the electronic cassette 32 via the connection portion 50B when the dummy connector is connected to the electronic cassette 32.

On the other hand, at the electronic cassette 32 relating to this example, the connection portion 32B is electrically connected to the cassette control section 26. In the state in which the dummy connector is connected to the electronic cassette 32, the CPU 51 of the dummy connector can, via the CPU 26A, control the state of the supply of electric power from the built-in power source 60.

In accordance with this structure, the CPU 51 can grasp that the dummy connector is connected to the electronic cassette 32, in accordance with whether or not communication with the CPU 26A of the cassette control section 26 is possible. Here, when the dummy connector is connected to the electronic cassette 32, the CPU 51 effects control, via the CPU 26A, such that the supply of electric power from the built-in power source 60 is cut-off, and effects control such that power source cut-off information is transmitted to the console 90 via the wireless communication section 27 and the like.

Note that, in this structure, various types of information such as information expressing the state of the supply of electric power from the built-in power source 60, information expressing the state of operation of the electronic cassette 32, and the like, can be displayed on the display section 56. Therefore, the convenience can be improved more.

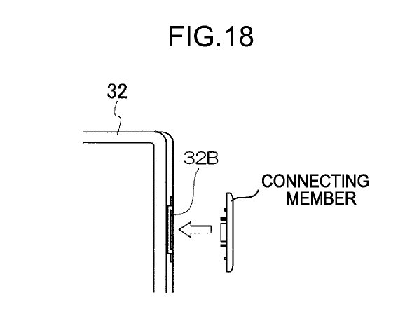

Further, the above-described respective exemplary embodiments describe cases in which the dummy connector, which has substantially the same shape and dimensions as the connector 43A of the communication cable 43 that is originally connected to the connection portion 32B of the electronic cassette 32, is used as the connecting member of the present invention. However, the present invention is not limited to the same. A connecting member that has a different shape or different dimensions than the connector 43A, such as shown in FIG. 18 for example, may be used. Note that the connecting member shown in FIG. 18 is thin as compared with the dummy connector shown in the above respective exemplary embodiments. Therefore, the protruding portion due to this connecting member when connected to the electronic cassette 32 can be made to be shorter, and as a result, the convenience and the like when transporting the electronic cassette 32 can be improved.

Moreover, the above-described respective exemplary embodiments describe cases in which the cutting-off/restarting of the supply of electric power from the built-in power source is switched by the contacting/separating of a portion of the dummy connector. However, the present invention is not limited to the same. For example, there may be a configuration in which an opening/closing element that opens and closes in a non-contact manner due to electromagnetic induction or magnetism or the like from the dummy connector when the dummy connector is connected to the electronic cassette, is provided on the path of electric power supply between the built-in power source and the respective destinations of the supply of electric power, and the cutting-off/restarting of the supply of electric power from the built-in power source is switched in accordance with the opening/closing operation of this opening/closing element.

Still further, the above-described respective exemplary embodiments describe cases in which the dummy connector is used as the cut-off section of the present invention. However, the present invention is not limited to the same, and there may be a form in which a simple cover, that covers the connection portion 32B of the electronic cassette 32, is applied.

In addition, the structures of the radiographic imaging system, the electronic cassette, the communication cable and the dummy connector that are described in the above exemplary embodiments (see FIG. 1 through FIG. 6, FIG. 9 through FIG. 10, FIG. 12, and FIG. 14 through FIG. 18) are examples, and unnecessary portions may be deleted therefrom, new portions may be added thereto, and the structures may be changed within a scope that does not deviate from the gist of the present invention.

What is claimed is:

1. A radiographic imaging system comprising:
a radiographic imaging device having a built-in power source for driving, and a connection portion for wired connection;
a connecting member that is structured so as to be able to be connected to the connection portion; and
a cut-off section that, if the connecting member is connected to the connection portion, cuts-off supply of electric power from the built-in power source at the radiographic imaging device.

2. The radiographic imaging system of claim 1, wherein
the connection portion is a portion to which is connected an external connection connector that is provided at a cable that connects the radiographic imaging device and an external device, and
the connecting member is a dummy connector of the external connection connector.

3. The radiographic imaging system of claim 2, wherein the cable has at least a function of supplying electric power from an exterior.

4. The radiographic imaging system of claim 3, further comprising:
a switching section that, if the external connection connector is connected to the connection portion, carries out switching such that electric power is supplied from the cable instead of the built-in power source.

5. The radiographic imaging system of claim 1, further comprising:
a transmitting section that, if the connecting member is connected to the connection portion, transmits power source cut-off information that expresses that the supply of electric power from the built-in power source is to be cut-off,
wherein the cut-off section cuts-off the supply of electric power from the built-in power source after the power source cut-off information is transmitted by the transmitting section.

6. The radiographic imaging system of claim 1, wherein the connecting member has a switch for switching a state of supplying and cutting-off of electric power from the built-in power source.

7. The radiographic imaging system of claim 1, wherein the cut-off section is provided at the radiographic imaging device or the connecting member.

8. The radiographic imaging system of claim 1, wherein the cut-off section electrically cuts-off the supply of electric power from the built-in power source.

9. The radiographic imaging system of claim 1, wherein the cut-off section mechanically cuts-off the supply of electric power from the built-in power source.

10. The radiographic imaging system of claim 1, wherein, during when the connecting member is connected to the connection portion, the connecting member seals a periphery of a region of connection.

11. The radiographic imaging system of claim 1, further comprising:
a restarting section that, if the connecting member is detached from the connection portion, restarts the supply of electric power from the built-in power source at the radiographic imaging device.

12. A connecting member comprising:
a second connection portion that is connected to a first connection portion for wired connection of a radiographic imaging device that has a built-in power source for driving and the connection portion; and
a cut-off section that, if the second connection portion is connected to the first connection portion, cuts-off supply of electric power from the built-in power source at the radiographic imaging device.

13. The connecting member of claim 12, further comprising:
a switch that switches a state between supplying and cutting-off of electric power from the built-in power source.

14. A radiographic imaging device comprising:
a built-in power source for driving;
a connection portion for wired connection; and
a cut-off section that cuts-off supply of electric power from the built-in power source if a connecting member, that is structured so as to be able to be connected to the connection portion, is connected to the connection portion.

15. A power source supply switching method comprising:
cutting off supply of electric power from a built-in power source for driving at a radiographic imaging device that has the built-in power source and a connection portion for wired connection, if a connecting member, that is structured so as to be able to be connected to the connection portion, is connected to the connection portion; and
restarting the supply of electric power from the built-in power source if the connecting member is detached from the connection portion.

16. A computer readable medium that stores a program for causing a computer to function as:
a cut-off section that cuts-off supply of electric power from a built-in power source for driving at a radiographic imaging device that has the built-in power source and a connection portion for wired connection, if a connecting member, that is structured so as to be able to be connected to the connection portion, is connected to the connection portion; and
a restarting section that restarts the supply of electric power from the built-in power source if the connecting member is detached from the connection portion.
